(19) United States
(12) Patent Application Publication
(10) Pub. No.: US 2008/0171149 A1
(43) Pub. Date: Jul. 17, 2008

(54) Inkjet Printing Ink

(76) Inventor: Ged Hastie, Newcastle Upon Tyne (GB)

Correspondence Address: SHELDON MAK ROSE & ANDERSON PC, 100 Corson Street, Third Floor, PASADENA, CA, 91103-3842, US

(21) Appl. No.: 11/569,347

(22) PCT Filed: May 19, 2005
(86) PCT No.: PCT/GB05/01894

§ 371 Date: Oct. 10, 2007

(30) Foreign Application Priority Data
May 19, 2004 (GB) 0411126.6
Nov. 15, 2004 (GB) 0425150.0

(51) Int. Cl. B05D 5/06; C09D 11/10

(52) U.S. Cl. 427/288; 524/590; 427/256

(57) ABSTRACT

The ink contains a colorant, a water soluble polymer capable of self crosslinking upon addition of elevated temperatures, water and other water miscible additives. The polymer may be a bisuphite adduct of a polyisocyanate polyurethane. The water soluble self-crosslinking polymer binds the colorant to a given substrate upon exposure to elevated temperatures. An image is inkjet printed to a substrate and fixed with heat to produce a durable image which has no effect on the perceived handle of the textile substrate.

This invention is in the field of digital printing, and is more specifically directed to an inkjet printing ink and to a method of printing an image onto a substrate by digital means using such ink, and subsequently activating the ink to permanently fix the printed image on the substrate.

Words, images and designs are frequently printed onto clothing and other textile materials, as well as other objects. The silk screen process is a stencil process well known in the art for printing images directly onto textiles as well as indirectly via transfer paper. The two main types of screen printing inks are pigmented emulsions and plastisol inks. The emulsion inks are typically based on aqueous dispersions of a binder and cross-linking agent. The emulsion inks are used for direct printing onto all types of fabric. After printing, the prints are fixed onto the textile by heat. The plastisol inks are typically vinyl resin dispersed in plasticizer. They may be applied directly onto the fabric or used as a transfer. When used as a transfer, the ink is screen printed onto a release paper, cured to a dry film, and stored until transferred to fabric by a heat transfer process.

U.S. Pat. No. 5,556,935 discloses a screen printing paste containing polyisocyanate mixtures comprising hydrophilic polyisocyanates, hydrophilic polyisocyanates containing carbidiimide groups, and/or polyepoxide compounds as cross-linking agents. However, these mixtures are insufficient under practical conditions; in particular, the finished printing pastes are not stable on storage. A continuous loss of isocyanate groups takes place through reaction of free isocyanate groups with water, which ultimately leads to products that are inactive with respect to crosslinking.

U.S. Pat. No. 4,849,262 discloses a screen printing paste and aqueous dyeing liquor containing particle dispersions of polyisocyanate cross-linking agent in a deactivated (partially blocked) form. The deactivation of the particle surfaces is achieved by the dispersion of polyisocyanates in the presence of media that are reactive with isocyanate. Only the isocyanate groups present on the surface of the particles react with the deactivating agent. The rest of the polyisocyanate molecules in the interior of the particle remain unreacted. The deactivation compounds form a sort of polymer shell on the surface of the polyisocyanate particles, which is removed with heat above 60° C. Apparently this shell imparts a prolonged pot life to the printing pastes, compared to prior art.

U.S. Pat. No. 5,607,482 discloses a screen printing paste containing a hydrophilic polyisocyanate prepolymer as a cross-linking agent. The isocyanate groups of the prepolymer are chemically blocked to prevent reaction. The blocking agent is removed with heat. Such print pastes show prolonged pot life due to both the complete blocking of reactive groups and the reduced number of reactive groups in the larger molecular weight prepolymer. Such a paste composition is limited to silk-screen and/or offset printing due to the physical properties of the paste. These include high solid percentage, high viscosity, and relatively large component particle sizes. The conditions required for a digital printing environment are different. Both physical and chemical properties need to be carefully adjusted in order to meet these conditions.

Although the silk-screen process is the predominant printing method for textiles, it does have certain disadvantages in today's digital computer age. Silk-screen is an analog printing process. As such it is not capable of matching the quality of digital graphics, especially photographic images. Nor can the process quickly or easily enable changes to be made to the print design. The use of digital computer technology allows a virtually instantaneous printing of images, each of which may be different from the other. Images are typically printed by a computer driven printer that will print colour inks from multiple ink reservoirs. Printing may be done directly onto the final substrate, such as a textile fabric, or onto an intermediate substrate, such as paper, followed by a transfer process.

The digital printing field utilizes various combinations of reactive species in an effort to create an ink with increased bonding to a paper substrate. U.S. Pat. No. 4,694,302 discloses an ink jet printing system which contains a reactive species present in the ink itself (one component system) or in a separate reservoir (two component system). The reaction of the reactive species with the substrate (one component system) or with the ink (two component system) forms a polymer which binds the dye onto the surface of the substrate. U.S. Pat. No. 5,380,769 and U.S. Pat. No. 5,645,888 describe inkjet ink compositions that contain at least two reactive components, a base ink which contains a crosslinkable constituent, and a curing component which is a crosslinking agent. The base ink and curing component are applied to a receiving substrate separately. The base ink is preferably applied first. Upon exposure of the base ink to the curing component, a durable, cross-linked ink is produced. Under circumstances where the crosslinkable constituent and the crosslinking agent are unreactive until a catalyst or other curing agent is introduced, both the crosslinkable constituent and a crosslinking agent may be incorporated in the ink carrier while the catalyst serves as a curing component.

U.S. Pat. No. 5,645,888 applies the base ink component to an intermediate support surface to be subsequently transferred to a desired receiving surface. The curing component may be applied to the intermediate support surface directly or in combination with an ink release agent.

In U.S. Pat. No. 4,694,302, U.S. Pat. No. 5,380,769 and U.S. Pat. No. 5,645,888, the printing process brings into contact all reactive components, which initiates the crosslinking reaction. For images printed onto an intermediate support, transfer to the desired receiving surface must be performed while the crosslinking reaction is still occurring, to achieve the maximum adherence and durability of the ink to the surface. There is no ability for long-term storage of printed images in an unreacted form.

U.S. Pat. No. 5,853,861 discloses a digital printing process, specifically ink jet printing, for direct printing onto a textile, rather than paper. The ink contains an aqueous carrier, a pigment and a polymer having acid, base, epoxy or hydroxyl functional moieties. The textile is pre-treated with a solution of either an organometallic crosslinking agent or an isocyanate crosslinking agent. Upon exposure of the printed image to an external energy source, the crosslinking agent reacts with the textile and the polymer in the ink to fix the image. However, the area of the textile outside the printed image also reacts with the crosslinking agent, possibly creating discoloration and a harsh hand. Also, as in U.S. Pat. No. 5,556,935, the crosslinking agents are not blocked from reaction. Therefore the life of the crosslinking agent in solution and on the fabric is severely reduced. Continuous loss of reactive groups ultimately leads to a textile which is inactive with respect to crosslinking.

Various inks for use in inkjet printers are known. Solvent-based inks, including both aqueous and non-aqueous inks, are well known. Solvent-based inks can be printed using piezoelectrically actuated printheads. Images are formed by the ejection of ink droplets onto a receiving surface and subsequent removal, such as by evaporation or diffusion, of one to all of the solvents. Phase change inks are solid at ambient temperatures and liquid at the elevated operating temperatures of an inkjet printing device. Ink jet droplets in the liquid phase are ejected from the printing device at an elevated operating temperature and rapidly solidify when they contact with the surface of a substrate to form the predetermined pattern. Thermal or bubble-jet devices use a heating element inside of the printing device to create instantaneous vapor bubbles that propel the ink to form small droplets from the print head and form the digitally oriented image. Continuous inkjet devices use printing ink with charging characteristics and with a continuous ink droplet flow through the printing transducer. By controlling the polarity of an electrode prior to the emit nozzle, the ejection of ink droplets from the nozzle is controlled.

U.S. Pat. No. 6,341,856 discloses a reactive ink comprising a colouring agent, a binder and at least one reactive species capable of being crosslinked by a second species to bond/crosslink the colouring agent onto a final substrate, such as a textile.

The first reactive species is a nucleophilic compound capable of being crosslinked through active hydrogen containing groups, such as amine, amido, carboxylic acid, hydroxyl, thiol, urethane, or urea groups or functional groups that can be converted into active hydrogen containing functional groups, such as a carboxylic acid derivatives (excluding anhydride groups).

The second reactive species is an electrophilic crosslinking agent, which is able to crosslink the above nucleophilic compounds by abstraction of their active hydrogen. The preferred crosslinking agents are isocyanates, epoxides, and other electrophilic crosslinking agents.

The ingredients and compounds from one or both reactive chemical groups form a stable emulsion or emulsion-like system. A separate reservoir of either or both reactive components may be utilized.

To prevent premature or undesired reaction, the nucleophilic and/or electrophilic functional groups are protected either by chemical blocking with blocking agents or by physical barrier such as encapsulating agents. With such protection, the second reactive species may be present with the first in the ink itself, or it may be printed onto the same area as the first reactive species from a separate ink reservoir. The protecting agents may be removed after printing by the application of energy or heat.

The image is printed either directly onto the final substrate, or it may be printed onto an intermediate substrate, such as paper, and subsequently transferred. Fixation of the ink onto the substrate is accomplished by reacting the agents in the ink, removing blocking agent(s) by the application of energy, such as heat and/or pressure. Since fixation is independent of the printing process, images can be stored for long periods of time prior to activation. Incorporation of all necessary reactive compounds in the printed image versus applying one or both reactive species to the final substrate allows for a wide selection of preferred substrates, including but not limited to textiles. It also provides good fixation onto the substrate surface, since the colorants are more thoroughly surrounded by the reactive compounds during the bonding/crosslinking process.

The images so produced have good colour fastness to laundering and abrasion.

The ink system in U.S. Pat. No. 6,341,856 is an emulsion or emulsion-like system, so that the ink system is relatively stable during storage and printing according to the processes described therein. However, emulsions are always sensitive to conditions, and the emulsion can easily be disturbed by characteristics such as particle. size and particle size distribution, pH value, charge density, viscosity, surface energy temperature etc. It would be much preferred if at least the binding system was a solution. The pigments are necessarily a dispersion, but a dispersion in a solution is much more stable than a dispersion in an emulsion.

Similarly, while it is feasible to keep separate the components of a binder system and to bring them together only at the time of application, this is an undesirable complication. It is preferable to have a single ink (of any particular colour) that is stable until it is activated by the application of an initiator, such as heat energy. This too is addressed by U.S. Pat. No. 6,341,856, which suggests the use of blocking agents, which inhibit reaction between the two components of the system, or encapsulation of one component, so that they can be mixed together and remain unreacted until the blocking agent is removed. However, the possibility arises, of an undesired reaction between the nucleophilic and electrophilic reactive species.

Thus it is an object of the present invention to provide an inkjet ink that is a solution, preferably aqueous, other than solid pigment particles dispersed in said solution, containing a binder activatable after printing on, or subsequent transfer to, a substrate to bind the pigment particles to the substrate.

In accordance with the present invention there is provided an inkjet ink comprising the following constituents, by weight:

| | |
|---|---|
| Solvent | 20-80% |
| Binder | 5-40% |
| Colourant | 0.5-10% |
| Humectant | 0-40% |
| Co-solvent | 0-40% |
| Dispersant | 0-20% |
| Additives | 0-5% |

wherein said binder comprises a self-crosslinkable polymer soluble in said solvent having carbomoyl groups of the formula —NH—CO—Xⁿ⁻, where X is an anionic water solubilising group and n is 1, 2 or 3, and said colourant is solid pigment particles dispersed in a solution of the remaining constituents. Preferably, X is SO₃⁻. X may be COO⁻.

Preferably, said components are in the ranges:

| | |
|---|---|
| Solvent | 50-70% |
| Binder | 10-20% |
| Colourant | 1-4% |
| Humectant | 5-20% |
| Co-solvent | 0-5% |
| Dispersant | 0-5% |
| Additives | 0.2-3% |

Presently, water is the preferred solvent, and the solution is aqueous, but the use of other solvents, with or without water, is not ruled out.

Preferably, said polymer is a polyether polyurethane. An example of such polymer is Synthappret® BAP, sold by Bayer AG, Leverkusen, Germany as an anti-felt finishing of wool and wool blends.

Thus, an image is inkjet printed with the ink of the present invention to a substrate and fixed with heat to produce a durable image which has no effect on the perceived handle of the textile substrate.

The carbomoyl sulphonate group is also referred to as a bisulphite adduct and is described in U.S. Pat. No. 3,898,197 as a blocked polyisocyanate composition. The chemistry of the unblocking is described in a paper: “Shrink resisting wool with Synthappret BAP: The effect of drying conditions” Cook, JR and Fleischfresser, BE, 1985, Textile Research Institute, Textile Research Journal, pp 607-614.

Without being limited to the correctness of the following theory, the reactions believed to take place at the carbomoyl group, in the presence of water and heat, are:

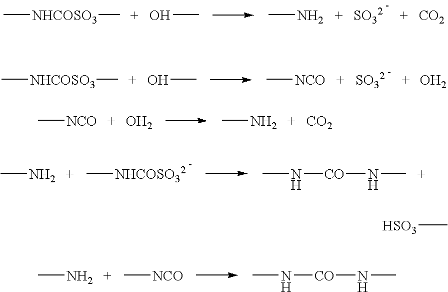

In the absence of such conditions, however, particularly heat involving temperatures in excess of 100° C., the carbomoyl group is stable. In the presence of such conditions, however, the result is crosslinking of the root polymer providing a polyisocyanate-linked network of the polyether polyurethane.

Furthermore, since the carbomoyl group is anionic it is soluble in water and the entire polymer to which it is attached can be rendered water soluble.

A functionality preferably of between two and four, for example, three, carbomoyl groups are provided on each polymer molecule.

It is possible that other ink components, such as colorants, humectants, co-solvents, dispersants, surfactants, etc. may contain chemically reactive sites to allow permanent bonding of every component of the image. The final substrate may also contain chemically reactive sites, allowing grafting of the image with the final substrate.

Such reactive functional groups may be provided in carbomoyl form, so that additional solubility in water is assured, as well as preventing premature binding to the binder.

Other additives may be required such as biocides, corrosion inhibitors, pigment dispersion additives, wetting agents, de-foamers, anti-freeze, and pH modifiers.

Indeed, an ink in accordance with the invention preferably has said additives including:
Oxidising Agent 0.01-2%
pH modifier 0.05-2%.

An oxidising agent minimises any fungal growth within the system. More importantly, however, such oxidising agent may also act to oxidise excess species present, such as bisulphite ions and sulphur dioxide.

Examples of suitable oxidising agents include chlorates, chlorites, hypochlorites, dichromates, persulphates, peroxides, nitrates and dichromates. Preferably, the oxidising agent is hydrogen peroxide.

It is common for some dyes to be more soluble under certain conditions and for some pigments to prefer systems in which a certain pH is maintained. In the majority of cases an alkaline environment is preferred. As such a pH modifier balances and stabilises the pH of the ink system.

Examples of suitable pH modifiers are amines, bicarbonates such as sodium bicarbonate, percarbonates such as sodium percarbonate, metal carbonates such as potassium carbonate, sodium hydroxide, ammonia, hydroxyl amines such as diethanolamine and triethanolamine.

In a preferred embodiment the pH modifier is sodium carbonate.

Ink-jet inks are known of three basic types: aqueous, non-aqueous, and hot-melt. The most common inks for drop-on-demand ink-jet printers for office quality output are aqueous-based inks, whereas non-aqueous inks are prevalent for continuous ink-jet printers, especially for industrial labelling. Phase change or hot-melt inks are typically used in drop-on-demand ink-jet printers and are based on waxes/resins. The ink formulation of the present invention is restricted to aqueous systems. Indeed, the great advantage of the present invention is its application in aqueous systems.

In general, the binder may have an average molecular weight from 500 to 50,000 and preferably, an average molecular weight in the range of 1,000 to 3,000.

The root polymer of the active binder may be a polyether, polyurethane, polyether polyurethane, polyester, polyester polyurethane or polyisocyanate prepolymers which are known to organic chemists.

The ink may include catalysts for the cross-linking reaction, however, the self cross-linkable polymer used does not require the addition of a catalyst and will readily cross-link when exposed to elevated temperatures. Examples of catalysts which may be used include tertiary amines, such as triethylamine, triethylenediamine, hexahydro-N,N′-dimethyl aniline, tribenzylamine, N-methyl-piperidine, N,N′-dimethylpiperazine; alkali or alkaline earth metal hydroxides, chlorides and carbonates; heavy metal ions, such as iron(III), manganese(III), vanadium(V) or metal salts such as lead oleate, lead-2-ethylhexanoate, zinc(II)octanoate, lead and cobalt napththenate, zinc(II)-ethylhexanoate, dibutyltin dilaurate, dibutyltin diacetate, and also bismuth, antimony and arsenic compounds, for example tributyl arsenic, triethylstilbene oxide or phenyldichlorostilbene.

The colorant may be organic and/or inorganic dyes or pigments. Indeed, almost any material which will lend colour, and which can be transported by the liquid carrier through the ink jet printer nozzles, may be used. Preferred colorants are pigment solids dispersed in the carrier to form a stable dispersion or colloid. The average particle size of the colorant in the dispersed ink system is normally from a few nanometres to several microns and preferably from 0.005 to less than one micron in diameter. Self dispersible pigments such as those described in U.S. Pat. No. 5,554,739 and U.S. Pat. No. 5,922,118 may be used as the colorant and provide extremely stable dispersions. During the image fixation process, colorants may be bound by physical entrapment within the image due to bonding/cross-linking of the reactive image compounds.

In the case of water-soluble colorants colourfastness is superior when the colourants are also bound by chemical bonds/cross-links, either with components of the ink, or with the final substrate. Colorants may be used that contain active functional groups capable of participating in the chemical crosslinking process. Preferred colorants are pigments which are highly dispersed within the ink formulation. Such pigments are known to provide superior fastness properties.

The ink may also contain other binding components. Typically, the ink binder is the “glue” that holds the ink onto the substrate, and in that respect the present invention is no exception as it contains an active self cross-linkable polymer which acts to trap mechanically the colorant to the desired substrate. Other binding components, if they were felt necessary or desirable, could take the form of a single resin or a complex combination of resins, plasticizers, and other additives. Binders impact the viscosity of the ink system and promote droplet formation. Binders also serve to adhere the colorant to the surface of the substrate, control the gloss of the colorant, control the definition of the print of the colorant, and determine the alkali solubility of the ink, among other purposes.

Such other binding components, if used, may be film forming, amorphous, low odour, colourless, pale or transparent. The components are preferably soluble or at least form a stable emulsion or colloid in the carrier system where surfactants, emulsifiers, humectants and/or co-solvents may be used in the ink. Either structured or random polymers may be selected for use as the other ink binding components. Structured polymers have a block, branched, or graft structure. Particularly preferred binders are those that can participate in the bonding/crosslinking of the reactive ink. They may also have carbomoyl groups or may be protected from premature reaction with blocking agents.

Examples of such other binding components include phenolics; acrylics such as poly(meth)acrylic acid and salts, polyacrylamide, polystyrene-acrylates; vinyl resins such as polyvinyl alcohol, polyvinyl acetate, and polyvinyl butyral; polyalkyleneoxides such as polyethylene oxide and polyethylene glycol; polyamides; polyamines such as polyvinylpyridine, polyvinylpyrrolidone, polyvinylamine, and polyethyleneimine; cellulose derivatives such as nitrocellulose, ethyl cellulose, ethyl hydroxyethyl cellulose, cellulose acetate butyrate, cellulose acetate propionate, and sodium carboxymethyl cellulose.

Other aqueous ink additives such as water miscible humectants, co-solvents, wetting agents, emulsifiers, solubilizers, charging agents, and dispersants may be used to assist in creating a stable emulsion or colloid of any hydrophobic components in the ink. Co-solvents may serve several functions. They act as humectants, i.e. they help minimize the evaporation of water and prevent crystallization of the dye/pigment inside the ink jet nozzle. Co-solvents also help control viscosity and the surface tension of the inks.

Preferred co-solvents include but are not limited to N-methyl pyrrolidone/pyrrolidinone and glycols, particularly ethylene glycol, diethylene glycol, propylene glycol, etc., as well as the ethers of such glycols, particularly mono-alkyl ethers. In general, straight-chain ethers are more effective viscosity-reducing agents than branched chain isomers and their efficiency increases with increasing the number of carbon atoms in the alkoxy groups.

Correctly selected co-solvents can improve the solubility of certain colorants thus producing more stable inks. Within thermal or bubble-jet systems such co-solvents enable the quick formation of vaporized bubbles. Examples of such co-solvents include 1-methoxy-2-propanol, iso-propanol, and iso-butyl vinyl ether.

Wetting agents may include such compounds as fatty acid alkanolamides, oxyethylene adducts from fatty alcohols or fatty amines. Other surface tension modifiers and/or interfacial modifiers include but not limited to di-, triethanolamine, amine oxide, sulfonated alkyl/fatty ester, aromatic/alkyl phosphate ester.

Common aqueous-based dye/pigment dispersants include such compounds as, fatty alcohol polyglycol ethers, and aromatic sulfonic acids, for instance naphthalene sulfonic acids. Some dispersants are polymeric acids or bases which act as electrolytes in aqueous solution in the presence of the proper counterions. Such polyelectrolytes provide electrostatic as well as steric stabilization of dispersed particles in the emulsion. Furthermore, they supply the ink with charging characteristics in continuous inkjet ink construction. Examples of polyacids include polysaccharides such as polyalginic acid and sodium carboxymethyl cellulose; polyacrylates such as polyacrylic acid, styrene-acrylate copolymers; polysulfonates such as polyvinylsulfonic acid, styrene-sulfonate copolymers; polyphosphates such as polymetaphosphoric acid; polydibasic acids (or hydrolyzed anhydrides), such as styrene-maleic acid copolymers; polytribasic acids such as acrylic acid-maleic acid copolymers. Examples of polybases include polyamines such as polyvinylamine, polyethyleneimine, poly(4-vinylpyridine); polyquaternary ammonium salts such as poly(4-vinyl-N-dodecyl pyridinium). Amphoteric polyelectrolytes may be obtained by the copolymerization of suitable acidic and basic monomers, for instance, methacrylic acid and vinyl pyridine.

Aqueous ink may also contain pH modifiers; anti-foaming chemicals such as silicone oil emulsions; fusion control agents; corrosion inhibitors; fungicides; antifreeze agents, such as ethylene glycol, propylene glycol, glycerol or sorbitol; antioxidants; and UV-light stabilizers.

In the present invention, the viscosity of the ink needs to be closely controlled in order to allow the ink to print through inkjet printing device. The viscosity value of the ink should be in the range of 1-30 cps, and preferably within a range of 3-10 cps. Viscous ink outside the range may result in printing difficulties, poor droplet size/shape forming and control, and/or damaged print orifices.

Surfactants can be very important in the processes of wetting, emulsification, dispersion, solubilization, ink drop forming and surface energy control or modification.

When surfactant concentration in a liquid carrier exceeds its critical micelle concentration (CMC), the molecules of the surfactant begin to aggregate. Aggregation of surfactants along with other ingredients forms micelles, or reverse micelles, depending on whether the main carrier phase is aqueous or non-aqueous. A typical structure has non-soluble liquid or solid ingredient particles or aggregates surrounded by surfactant molecule layer. An essentially homogenous, but multi-phase, system is therefore generated, with small isolated micelle droplets carrying colorants, binders, miscible or non-miscible co-solvents and/or humectants, additives, etc. inside the micelle structure. The micelles are suspended in the major carrier phase and prevent further aggregation or phase separation. These micelle particles are small enough in size to create a free flow liquid applicable in inkjet printing without clogging the printing mechanism. They also protect the ingredients, especially the heat-sensitive materials inside the micelle particles having a direct contact with each other, and/or having a direct contact with printing mechanisms such as a heating element in thermal or bubble-jet inkjet printing. The non-soluble, non-miscible ingredients used in the application therefore can be stabilized with useable concentration.

In order to create a stable dispersion or colloid ink system, at least one surfactant/dispersant/dispersing mechanism should be used. Multiple surfactants/dispersants can also be used in combination to further enhance the protection, stability, flow characteristics, and printing performance, provided such material does not have any negative impact on the reactive ingredients during the storage and image generating processes. Furthermore, depending on the CMC value, hydrophilic-lipophilic balance (HLB) value, and/or other characteristics of the surfactant/dispersant, different concentrations can be used to obtain best performance of the ink system corresponding to a specific printing mechanism.

Examples of surfactants and emulsifiers/dispersants include alkylaryl polyether alcohol nonionic surfactants, such as Triton X series (Octylphenoxy-polyethoxyethanol); alkylamine ethoxylates nonionic surfactants such as Triton FW series, Triton CF-10, and Tergitol (Union Carbide Chemicals); polysorbate products such as Tween (ICI Chemicals and Polymers); polyalkylene and polyalkylene modified surfactants, such as Silwet surfactants (polydimethylsioxane copolymers) and CoatOSil surfactants from OSI Specialties; alcohol alkoxylates nonionic surfactants, such as Renex, BRIJ, and Ukanil; Sorbitan ester products such as Span and Arlacel; alkoxylated esters/PEG products, such as Tween, Atlas, Myrj and Cirrasol surfactants from ICI Chemicals and Polymers; unsaturated alcohol products such as surfynol series surfactants from Air Products Co., alkyl phosphoric acid ester surfactant products, such as amyl acid phosphate, Chemphos TR-421; alkyl amine oxide such as Chemoxide series from Chemron Corporation; anionic sarcosinate surfactants such as Hamposyl series from Hampshire Chemical corporation; glycerol esters or polyglycol ester nonionic surfactants such Hodag series from Calgene Chemical, Alphenate (Henkel-Nopco), Solegal W (Hoechst AG), Emultex (Auschem SpA); and polyethylene glycol ether surfactants such as Newkalgen from Takemoto Oil and Fat Co. and other commercial surfactants known to those skilled in the art.

In addition to creating a stable emulsion, dispersion or colloid ink system, surfactants are also used for surface energy or surface tension control. In either aqueous or non-aqueous case, the surface tension of the final ink should range from 20 dyne/cm to 55 dyne/cm and preferably from 35 dyne/cm to 45 dyne/cm.

The final transfer substrate may include plastics, metals, wood, glass, ceramics, paper, or textile materials. Preferred are textile materials including such materials as cotton, secondary cellulose acetate, rayon, wool, silk, and polyamides such as nylon 6, nylon 66 or nylon 12. The substrates must be able to withstand the heat transfer temperature without deforming, melting or degrading. The final substrate may either contain compounds that have active groups have a surface coating containing such groups. Chemical grafting is achieved through crosslinking between the ink layer components and final substrate material, resulting in superior stability and durability.

Thermally expandable ink may be produced, if desired, in which the ink and/or the medium comprises an expanding agent. Simultaneous expanding and cross-linking gives a three-dimensional image which is permanently bound to the substrate. The height of the image is dependent on the concentration of expanding agent, the temperature and the pressure applied during heat transfer printing.

Preferable expanding agents include those which decompose upon heating to release gaseous products which cause the ink to expand. Such expanding agents, known as chemical blowing agents include organic expanding agents such as azo compounds which include azobisisobutyronitrile, azodicarbonamide, and diazoaminobenzene, nitroso compounds such as N,N′-dinitrosopentamethyl-enetetramine, N,N′-dinitroso-N,N′-dimethylterephthalamide, sulfonyl hydrazides such as benzenesulfonyl hydrazide, p-toluenesulfonyl hydrazide, p-toluenesulfonyl azide, hydrazolcarbonamide, acetone-p-sulfonyl hydrazone; and inorganic expanding agents, such as sodium bicarbonate, ammonium carbonate and ammonium bicarbonate.

Thermally expandable ink may alternately be produced by the use of volatile hydrocarbons encapsulated in a microsphere that ruptures upon the application of heat. The gaseous products released expand the ink. These thermally expandable microcapsules are composed of a hydrocarbon, which is volatile at low temperatures, positioned within a wall of thermoplastic resin. Examples of hydrocarbons suitable for practicing the present invention are methyl chloride, methyl bromide, trichloroethane, dichioroethane, n-butane, n-heptane, n-propane, n-hexane, n-pentane, isobutane, isophetane, neopentane, petroleum ether, and aliphatic hydrocarbon containing fluorine such as Freon, or a mixture thereof.

The invention is further described hereinafter, by way of example, with reference to the following non-limiting Examples of the invention.

### EXAMPLES

### Example Formulation Composition 1

| Function | Source | | % by weight |
|---|---|---|---|
| Water | Deionised | | 40.7 |
| Binder | Synthappret ® BAP¹ | | 15 |
| Colorant | Cab-o-jet 250² (Cyan) | | 30 |
| | (equivalent to 3% solids) | | |
| Humectants | diethylene glycol | | 10 |
| | glycol ether | | 2 |
| | isopropanol | | 1 |
| Co-solvent | ethanol | | 1 |
| pH modifier | Sodium Carbonate | | 0.1 |
| Oxidising Agent | Hydrogen Peroxide | | 0.1 |
| Biocide | Proxel GXL³ | | |
| Defoamer | BYK 024 | {close oversize brace} | 0.1 |
| Wetting Agent | BYK 348 | | |

¹Bayer AG
²Cabot Corporation
³Avecia

Physical Properties of Ink

Viscosity—12 cps

Surface tension—40 dynes/cm

pH—7-8

Particle size—0.01 to 0.08 μm

### Example Formulation Composition 2

| Function | Source | | % by weight |
|---|---|---|---|
| Water | Deionised | | 74.7 |
| Binder | Synthappret ® BAP¹ | | 10 |
| Colorant | Cab-o-jet 200² (Black) | | 10 |
| | (equivalent to 3% solids) | | |
| Humectants | diethylene glycol | | 5 |
| pH modifier | Sodium Carbonate | | 0.1 |
| Oxidising Agent | Hydrogen Peroxide | | 0.1 |
| Biocide | Proxel GXL³ | | |
| Defoamer | BYK 024 | {close oversize brace} | 0.1 |
| Wetting Agent | BYK 348 | | |

¹Bayer AG
²Cabot Corporation
³Avecia

Physical Properties of Ink

Viscosity—12 cps

Surface tension—40 dynes/cm

pH—7-8

Particle size—0.01 to 0.08 μm

### Example Formulation Composition 3

| Function | Source | % by weight |
|---|---|---|
| Water | Deionised | 80 |
| Binder | Synthappret ® BAP¹ | 5 |
| Colorant | Hostaperm M EO2⁴ | 2 |
| Humectants | diethylene glycol | 5 |
| Additives | | 1 |
| Dispersant | Disperbyk 192⁵ | 7 |

⁴Clariant
⁵BYK Chemie
Notes:
This ink formulation printed well. However, the ink exhibited a low colour strength. This was due to the minimum levels of both colourant and binder. Some flocculation and settling problems were also observed due to the relatively low levels of dispersant.

Physical Properties of Ink

Viscosity—3 cps

Surface tension—32 dynes/cm

pH—7-8

### Example Formulation Composition 4

| Function | Source | % by weight |
|---|---|---|
| Water | Deionised | 20 |
| Binder | Synthappret ® BAP¹ | 40 |
| Colorant | Hostaperm M EO2⁵ | 3 |
| Humectants | glycol ether | 20 |
| Co-solvent | Iso propanol | 12 |
| Dispersant | Disperbyk 192⁶ | 5 |

This ink had a high viscosity and was at the limit of satisfactory inkjet printing due to the high level of binder included.

### Example Formulation Composition 5

| Function | Source | % by weight |
|---|---|---|
| Water | Deionised | 22 |
| Binder | Synthappret ® BAP¹ | 15 |
| Colorant | Cab-o-jet 250² | 23 |
| Humectants | diethylene glycol | 40 |

This ink was stable. Printing was satisfactory, however, viscosity levels were relatively high due to the high humectant concentration.

### Example Formulation Composition 6

| Function | Source | % by weight |
|---|---|---|
| Water | Deionised | 29.5 |
| Binder | Synthappret ® BAP¹ | 15 |
| Colorant | Cab-o-jet 250² | 30 (of which |
| | | 3% is pigment solids) |
| Humectants | diethylene glycol | 20 |
| Co-solvent | isopropanol | 5 |
| Additives | | 0.5 |

The ink was stable. Printing tests were successful. Fatness tests to printed textiles showed high levels of image stability.

Process in Ink Formulation

Water and humectants are blended using a mechanical stirring process. If needed the pH is adjusted using AMP to maintain at 7-8. Other additives are also added at this point, including the binder. Synthappret BAP is completely water miscible so a homogenous solution is formed (i.e. not an emulsion). The pigment dispersion is added last. The formulation is then mechanically stirred until a satisfactory mix has been formed. The preferred colorants, previously referred to and detailed in U.S. Pat. Nos. 5,554,739 and 5,922,118, may not require a high speed milling stage. However, other colorants may require the application of a high shear mixing process in order to ensure a stable dispersion or colloid.

Printing and Curing Process

Inks are introduced into inkjet cartridges. The inkjet printer can be thermal or piezo, desktop or wide format. An image is printed directly to an untreated textile fabric. A wide array of textile fabrics may be used e.g. cotton, polyester (blends thereof), silk, wool etc. The ink is not textile specific. The ink also prints to treated textiles, however the ink has the advantage of printing to cheaper untreated fabrics.

Once the image has been created, the ink is fixed to the textile substrate by means of heat. The heating methods can take the form of dry heat (air flow), heat press, or steam. The temperature can vary from between 100-200° C. Once cured, the fabric confers excellent handle properties and performs excellently in wash, rub and lightfastness testing.

1. An inkjet ink comprising the following constituents, by weight:

| | |
|---|---|
| Solvent | 20-80% |
| Binder | 5-40% |
| Colourant | 0.5-10% |
| Humectant | 0-40% |
| Co-solvent | 0-40% |
| Dispersant | 0-20% |
| Additives | 0-5% |

wherein said binder comprises a self-crosslinkable polymer soluble in said solvent and having carbomoyl groups of the formula —NH—CO—Xⁿ⁻, where X is an anionic water solubilising group, n is 1, 2 or 3 and said colorant is solid pigment particles dispersed in a solution of the remaining constituents.

2. An inkjet ink as claimed in claim 1, comprising the following constituents, by weight:

| | |
|---|---|
| Solvent | 50-70% |
| Binder | 10-20% |
| Colourant | 1-4% |
| Humectant | 5-20% |
| Co-solvent | 0-5% |
| Dispersant | 0-5% |
| Additives | 0.2-3% |

3. An inkjet ink as claimed in claim 1, wherein said solvent is water.

4. An inkjet ink as claimed in claim 1, wherein said solution is aqueous.

5. An ink as claimed in claim 1, wherein the anionic solubilising group is SO₃⁻.

6. An ink as claimed in claim 1, wherein said polymer is a polyether polyurethane.

7. An ink as claimed in claim 6, wherein said binder is Synthappret® BAP.

8. An ink as claimed in claim 1, wherein a functionality of between two and four carbomoyl groups are provided on each polymer molecule.

9. An ink as claimed in claim 1, wherein said colorant is a Cab-o-jet® dispersion.

10. An ink as claimed in claim 1, wherein said additives include:
Oxidising Agent 0.01-2%
pH modifier 0.05-2%.

11. An ink as claimed in claim 10, wherein said oxidizing agent is hydrogen peroxide.

12. An ink as claimed in claim 10, wherein said pH modifier is sodium carbonate.

13. A method of rendering an image on a final substrate, comprising inkjet printing said image with ink as claimed in claim 1, and fixing said image on the substrate with heat to produce a durable image.

14. A method as claimed in claim 13, wherein said heat raises the temperature of the ink on the substrate to between 100 and 200° C.

15. A method as claimed in claim 13, wherein said image is printed directly onto to said substrate.

16. A method as claimed in claim 13, wherein said substrate is a textile.

17. (canceled)

18. An inkjet ink comprising solvent, binder and colorant, wherein said binder comprises a self-crosslinkable polymer soluble in said solvent and having carbomoyl groups of the formula —NH—CO—Xⁿ⁻, where X is an anionic water solubilising group, n is 1, 2 or 3 and said colorant is solid pigment particles dispersed in a solution of the remaining constituents.

19. An inkjet ink as claimed in claim 18, wherein said solvent is water and said solution is aqueous.

20. An ink as claimed in claim 18 comprising the following constituents, by weight:

| | |
|---|---|
| Water | 30-70% |
| Binder | 5-30% |
| Colorant | 0.5-10% |
| Oxidising Agent | 0.05-2% |
| pH modifier | 0.05-2% |
| Humectant | 0-40% |
| Co-solvent | 0-40% |
| Dispersant | 0-20% |
| Additives | 0-5%. |
